(19) United States
(12) Patent Application Publication
(10) Pub. No.: US 2016/0248767 A1
(43) Pub. Date: Aug. 25, 2016

(54) METHOD AND SYSTEM FOR SECURE COMMUNICATIONS

(71) Applicant: Apollo Education Group, Inc., San Jose, CA (US)

(72) Inventor: David Le, San Jose, CA (US)

(21) Appl. No.: 14/628,887

(22) Filed: Feb. 23, 2015

(51) Int. Cl. H04L 29/06

(52) U.S. Cl. CPC H04L 63/0861; H04L 63/0428

(57) ABSTRACT

An operator of a first device is verified using biometric data detected by the first device. Responsive to successfully completing the verification, the first device data in a decrypted form that is displayed in an encrypted form on a second device.

### TECHNICAL FIELD

The present disclosure relates to secure communications. In particular, the present disclosure relates to securely displaying data to authorized users and/or securely accepting user input from authorized users.

### BACKGROUND

Data is presented to users using a variety of devices such as, for example, desktop machines, laptops, phones, tablets, and phablets. Users view data on the devices as well as provide user input via the devices. Data security is an important concern as the data is often sensitive and cannot be shared with non-intended users. Users must be verified to ensure that user input is received from the intended user. To enforce data security, many different types of encryption mechanisms and user verification methods are implemented in today's systems.

In one example, a first student that is logging into an online educational course using a desktop machine may be required to enter a username and password which is verified against a list of authorized log-ins for the online educational course. An online exam is then displayed to the first student via a browser or other application installed on the first user's desktop machine. However, even after the first student has entered the correct username and password, another different second student maybe concurrently viewing the online exam on the student's desktop machine and providing answers to the first student that logged-in. In another scenario, a third student in the same class may be viewing the desktop machine of the first student to cheat by copying answers being entered by the first student. In another scenario, the first student may provide his log-in information to a fourth student. The fourth student logs-in using the log-in information corresponding to the first student and helps the first student cheat by taking the exam for the first student.

The approaches described in this section are approaches that could be pursued, but not necessarily approaches that have been previously conceived or pursued. Therefore, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for performing a synchronization operation in accordance with one or more embodiments;

FIG. 3 illustrates an example set of operations for performing a synchronization operation in accordance with one or more embodiments;

FIG. 4 illustrates a system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention. The detailed description includes the following sections:
1. GENERAL OVERVIEW
2. ARCHITECTURAL OVERVIEW
3. DISPLAYING DATA BY A DEVICE
   3.1 VERIFYING A USER OF A FIRST DEVICE
   3.2 DISPLAYING ENCRYPTED DATA ON A SECOND DEVICE
   3.3 OBTAINING AND DISPLAYING DECRYPTED DATA CORRESPONDING TO THE ENCRYPTED DATA DISPLAYED ON THE SECOND DEVICE
   3.3 DISPLAYING DECRYPTED DATA ON THE FIRST DEVICE
   3.4 UPDATING USER VERIFICATION
4. DETAILED EXAMPLE
5. SECURE EXAMINATION PROCEDURE
6. MISCELLANEOUS; EXTENSIONS
7. HARDWARE OVERVIEW

### 1. General Overview

One or more embodiments relate to displaying data in an unencrypted form on a first device operated by an authorized entity. The data is displayed in an encrypted form on a second device and displayed in the decrypted form on the first device at least in response to verification of the operator of the first device as an authorized entity.

One or more embodiments relate to a secure examination procedure. Questions and/or answer choices corresponding to an examination are displayed on a client device subsequent to verification of an operator's biometric information.

### 2. Architectural Overview

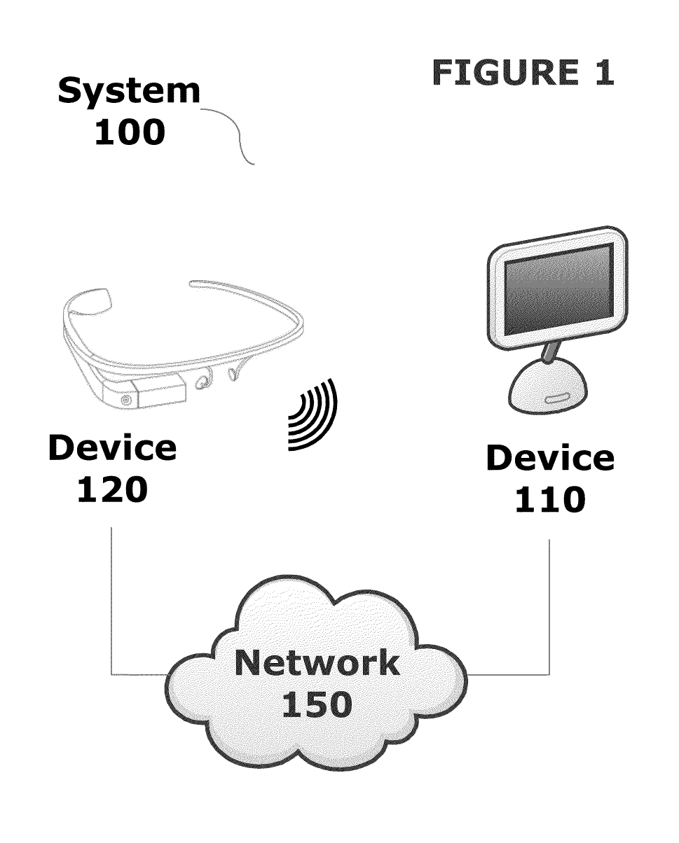

FIG. 1 illustrates a system (100) in accordance with one or more embodiments. Although a specific system is described, other embodiments are applicable to any system that can be used to perform the functionality described herein. Additional or alternate components may be included that perform functions described herein. Components described herein may be altogether omitted in one or more embodiments. One or more components described within system (100) may be combined together in a single device.

Components of the system (100) are connected by, without limitation, a network such as a Local Area Network (LAN), Wide Area Network (WAN), the Internet, Intranet, Extranet, and/or satellite links. Any number of devices connected within the system (100) may be directly connected to each other through wired and/or wireless communication segments (e.g., via Network (150)). In one example, devices within system (100) are connected via a direct wireless connection such a Bluetooth connection, a Near Field Communication (NFC) connection, and/or a direct Wi-Fi connection.

In an embodiment, device (110) generally represents any device that includes a hardware processor and a display component (e.g., a screen or a projection mechanism). Examples of devices in accordance with one or more embodiments include, but are not limited to, a desktop, a laptop, a tablet, a phablet, a cellular phone, a smart phone, a Personal Digital Assistant (PDA), a kiosk, and a projector.

In an embodiment, the data storage of device (110) includes a fast read-write memory for storing programs and data during the execution of an operating system and a hierarchy of persistent memory such as ROM, EPROM, and Flash memory for storing instructions and data needed for the startup and/or operations of device (110). In an embodiment, the I/O interface of device (110) corresponds to one or more components used for communicating with other devices via wired or wireless segments. The I/O interface may include a wired network interface such as an IEEE 802.3 Ethernet interface and/or a wireless interface such as an IEEE 802.11 Wi-Fi® interface.

In an embodiment, a processor is coupled to the data storage and the I/O interface. The processor may be any processing device including, but not limited to a MIPS-class processor, a microprocessor, a digital signal processor, an application specific integrated circuit, a microcontroller, a state machine, or any type of programmable logic array.

In an embodiment, device (120) is a wearable device comprising functionality to display data to a user that is wearing device (120). Device (120) includes devices such that a user that is wearing device (120) can view all of the data, and where some minor portions of a display by device (120) can be viewed by other nearby users. Data as referred to herein includes any type of viewable media such as text, images, and video.

In an embodiment, device (120) comprises an optical head-mounted display (OHMD) to display data to a user. Examples of devices with OHMD include but are not limited to:

TABLE 1

| Company | Product with OHMD |
|---|---|
| MicroOptical | MicroOptical MV-1 |
| Sony | Glasstron |
| IMG Japan and Olympus Optical | PC Eye-Trek |
| Vuzix | SMART Glasses |
| Google | Google Glass |
| Fujitsu | Laser Head Set (LHS) |
| Innovega | iOptik system |

In an embodiment, device (120) comprises a camera. In an example, device (120) is worn by a user similar to a pair of glasses resting on a user's ears. In another example, device (120) is worn by a user similar to a helmet gripping a user's head. The user wears device (120) such that the camera of device (120) captures data (for example, an Augmented Reality Image Marker) displayed by device (110).

In an embodiment, device (120) comprises an audio component for playing an audio file. Examples of an audio component include headphones and speakers. Device (120) may receive an audio file from device (110) or from any other local or remote device. A multimedia file comprising both audio and video segments may be played by device (120) using the audio component and the OHMD.

In an embodiment, device (120) comprises one or more input components. Input components may include but are not limited to touch pads, buttons, touch screens, scrollable wheels, and sensors. In an example, device (120) includes sensors that detect hand movement by a user. The hand movement is translated to corresponding user input and processed by device (120). In one example, device (120) is configured to display exam questions to a student using the OHMD and accept exam answers from the student via a touch pad. In an example, device (120) tracks eye movement and detects input based on the eye movement.

### 3. Displaying Data by a Device

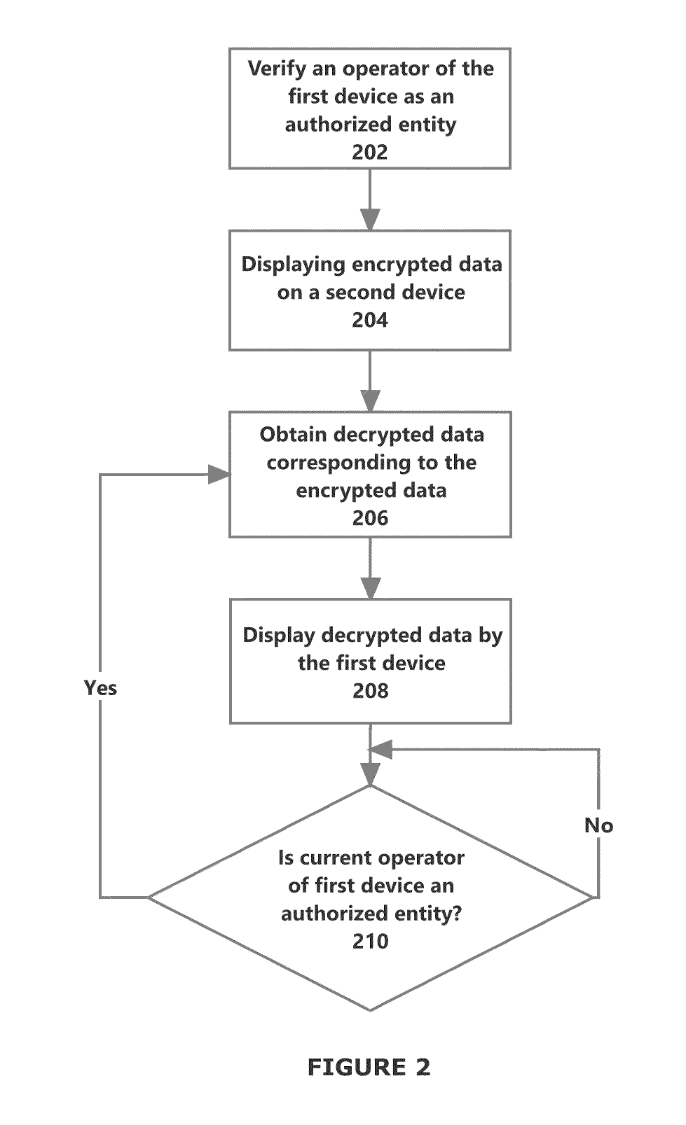

FIG. 2 illustrates an example set of operations for displaying data. Operations for displaying data, as described herein with reference to FIG. 2, may be omitted, rearranged, or modified. Furthermore, operations may be added or performed by components or devices different than the specifically mentioned components or devices. Accordingly, the specific set or sequence of operations should not be construed as limiting the scope of any of the embodiments.

Operations referred to in relation to FIG. 2 refer to a first device that is worn by a user. Examples of the first device are provided in Table 1 and described with relation to device (120) illustrated in FIG. 1. Further, operations referred to in relation to FIG. 2 refer to a second device. Examples of the second device are described with relation to device (110) illustrated in FIG. 1.

3.1 Verifying an Operator of a First Device as an Authorized Entity

In an embodiment, a first device is a wearable device that is worn by a user (referred to herein as an “operator”). The operator of the first device is verified as an authorized entity for accessing data that is to be presented by the first device (Operation 202).

Verifying the operator of the first device includes performing a single level verification or a multiple level verification using different verification mechanisms. In an example, biometric information for an operator is detected by the first device while the operator is wearing the first device. The biometric information may include, but is not limited to, fingerprint information, voice information, DNA information, and iris information. The iris information is captured by a camera taking images of an operator's eyes. The biometric information for the operator that is detected by the first device is transmitted to a web server. The web server compares the received biometric information to a database of biometric information for entities authorized to access the data that is to be presented by the first device. If the received biometric information matches the biometric information stored in the database, then the operator of the first device is determined to be an authorized entity. If the received biometric information does not match any biometric information stored in the database, then the operator of the first device is determined to be an unauthorized entity. In an example, the first device transmits the images of an operator's eyes. Patterns within the iris of the operator's eyes are recognized by applying mathematical pattern-recognition techniques. The patterns are then compared to stored patterns corresponding to authorized entities to determine if the operator's eyes match those of an authorized entity. In another example, fingerprint information is detected when a user touches a surface of the first device which gathers input based on contact. DNA information is detected, for example, from sweat collected from an operator's temple when the first device is placed in contact with the operator's temple. Although the verification process is described above as being performed by a web server, any device (for example, first device or second device) may perform the verification process.

In an example, voice recognition may be implemented to ensure that all voices detected near the first device correspond to the authorized entity using the first device. The detected voices are recorded and compared to voices of authorized entities. If the detected voices match the stored voices of authorized entities, then a determination that the detected voices correspond to authorized entities. If a detected voice does not match the stored voices of authorized entities, a determination is made that an unauthorized entity is present. In response to detecting an authorized entity, the system may stop operations (for example, stop the first device from displaying data) and transmit an alert. In an embodiment, when an unauthorized entity is detected (e.g., by voice or other verification test), monitoring by cameras is activated. In an example, in response to detecting an unauthorized entity using the first device or being present near the first device, a video camera on the second device begins recording the operator of the first device. Alternatively, a media file (which corresponds to ongoing recording initiated prior to detection of the unauthorized entity) is flagged for review by an administrator.

A multiple level verification may be performed using multiple verification tests with the first device worn by the user and/or by performing verification tests using multiple devices. In an example, the user must pass an iris verification test while wearing the first device and in addition successfully log-in to an online portal via a second device (e.g., a laptop). The system may require the user to log-in before or after the iris verification test.

In an embodiment, continuous, periodic, or event-based verification is performed to ensure that an operator of the first device has not changed since the previous successful verification. In an example, verification is performed each time a new set of data is presented to the operator of the first device via an OHMD component.

3.2 Displaying Encrypted Data on a Second Device

In an embodiment, encrypted data is displayed on the second device (Operation 204). Displaying encrypted data on the second device includes displaying any representation of the data such that the underlying data cannot be deciphered by a user. In an example, the encrypted data includes an Augmented Reality (AR) image marker that is displayed on a desktop machine, the second device. While users sitting next to the desktop machine can see the AR image marker, the users are unable to determine the text, image, or video (i.e., the underlying data) corresponding to the AR image marker by simply looking at the AR image marker.

In another example, displaying encrypted data on the second device includes a projector displaying a Quick Response (QR) code or a bar code. While users can see the QR code or bar code on a screen where the QR code or bar code is projected, the users are unable to determine the text, image, or video corresponding to the QR code or the bar code by simply looking at the QR code or bar code.

In an example, displaying encrypted data comprises displaying an encrypted version of text. Data corresponds to a question “Who was the first president of the United States?” The encrypted data, obtained by applying an encryption function to the data using an encryption key, reads as “@#$!#@ #$#@$!!!#% @#!#%*@(#/”. Symmetric and/or asymmetric keys may be used for encryption and decryption in accordance with various embodiments.

3.3 Obtaining and Displaying Decrypted Data on the First Device Corresponding to the Encrypted Data Displayed on the Second Device

In an embodiment, decrypted data, corresponding to the encrypted data displayed on the second device, is obtained by the first device (Operation 206) and displayed by the first device (Operation 208). The decrypted data is displayed subsequent to verifying the operator of the first device as an authorized entity as described above in relation to Operation 202.

In one embodiment, the encrypted data is transmitted to the first device. In an example, the second device displaying the encrypted data transmits a copy of the encrypted data to the first device. In another embodiment, obtaining decrypted data includes the first device detecting the encrypted data displayed on the second device via a camera on the first device. The encrypted data is then decrypted by the first device using a decryption key. The decryption key is received by the first device from a server in response to the server successfully verifying the operator of the first device as an authorized entity. Alternatively, a program executing on the first device permanently stores the decryption key on the first device itself, and uses the decryption key in response to verification of the first device as an authorized entity. The verification may be performed by (a) the first device itself or (b) by a separate device (for example, a server, the second device, etc.) based on the biometric data detected and transmitted by the first device. The first device then displays the decrypted data such that the decrypted data is visible to the user wearing the first device.

In an embodiment, the encrypted data represents multiple different versions of a data set. A lookup is performed using the encrypted data to identify the multiple different versions of the data set. A particular version of data from the data set is then selected based on on which authorized entity is attempting to access the data. In an example, obtaining decrypted data includes the first device detecting the encrypted data displayed on the second device. The encrypted data comprises a QR code. The first device provides the QR code and the biometric information of the operator to a server. The server verifies the biometric information as corresponding to a student in Calculus 101. The server then identifies multiple versions of a Calculus 101 semi-final examination based on the QR code and selects a particular version of the Calculus 101 semi-final examination based on the student. Specifically, the server applies a hash function to an identifier associated with the student to obtain a hash value. The server then selects the particular version of the Calculus 101 semi-final examination that has been mapped to the computed hash value. Different versions of the examination may have different answer choices, different questions, a different order of questions, a different order of answers, etc. The selected particular version of the Calculus 101 semi-final examination is transmitted to the first device for display to the student.

In another example, obtaining decrypted data corresponding to the encrypted data displayed on the second device includes accessing data stored on the first device. In an example, an AR image marker, displayed by a classroom projector (second device), is detected by a camera on a OHMD device (first device) worn by a student. The OHMD device identifies the data corresponding to the AR image marker from data stored on the OHMD device itself. The OHMD device displays the identified data subsequent to verification of an operator of the OHMD device as an authorized entity.

3.4 Repeating User Verification

In an embodiment, verification of an operator of the first device is repeated to determine whether the current operator is an authorized entity (Operation 210). Repeating verification of an operator may include performing a complete set of verification operations again as initially performed, repeating only a portion of the verification operations, and/or performing a different set of verification operations.

In an example, a first verification procedure includes prompting the operator to provide a username and password on the second device (e.g., a laptop), and detecting biometric information of the operator via the first device (e.g., Google Glass). When the verification is repeated, the operator is not prompted to re-enter the username and password, however, the biometric information of the operator is detected again and verified.

In an embodiment, verification of the operator of the first device is repeated periodically, continuously, and/or in response to a particular event. In an example, prior to displaying each examination question or accepting each examination answer, the biometric information for an operator is detected and verified.

In an example, a first student, Mark begins an online examination using an OHMD device after successful verification as an authorized entity. Subsequent to beginning the examination, Mark cheats by transferring his OHMD device to Joe to continue the examination as Mark. The OHMD device which performs a periodic verification every two minutes detects biometric information corresponding to the current user two minutes after the previous successful verification. Since Joe is now operating the OHMD device, the OHMD device detects Joe's biometric information. The OHMD device transmits Joe's biometric information to a server which compares Joe's biometric information to a database of biometric information corresponding to authorized users. The server determines that Joe's biometric information does not match the biometric information of any authorized user. The server transmits a notification to the OHMD device, and in response, the OHMD device immediately stops displaying information related to the examination. In an alternate embodiment, the repeated verification procedures are configured to ensure that the initially authorized user has not changed. In the above example, the server is configured to compare Joe's biometric information to Mark's biometric information since Mark initiated the examination. Joe's biometric information fails to match Mark's biometric information triggering an alert and/or causing a termination of the examination. In this example, Joe may have been another student in Mark's class such that Joe's biometric information corresponds to biometric information stored for authorized entities. However, the change in operator during an examination detected by the system results in the triggering of an alert and/or terminating the examination. The alert includes, in one example, notifying an administrator of the exam of the detected change in operator. The alert may further identify the sequence of events including detecting Mark as an initial operator and a change in operator to Joe while the examination was being presented.

### 4. Detailed Example

In one detailed example described below, a student Jessica takes an examination for an online course. This example has numerous specific details described for purposes of explanation and should not be construed to limit the scope of any embodiments.

Jessica puts on glass wear which has a display screen only visible to Jessica. An application executing on the glass wear detects images of Jessica's iris and transmits the images to a server. The server matches patterns in Jessica's iris to recorded patterns associated with Jessica's profile and determines that the operator of the glass wear is in fact Jessica, a student in an online course, Economics 101. Subsequent to successfully verifying Jessica as a student in the online course, the application receives a decryption key from the server, the decryption key corresponding to the online course. Jessica also signs into the online course via a browser executing on a tablet. After logging into the online course via the tablet, Jessica browses to an online exam screen using the tablet. The tablet displays Augmented Reality (AR) image markers for questions and answer choices on the exam. While the AR image markers are displayed on the tablet, the questions and answer choices corresponding to the AR image markers are not displayed on the tablet. The glass wear, worn by Jessica, captures an image of the AR image markers displayed on the tablet via a camera. The glass wear applies the decryption key to the AR image markers to obtain the questions and answer choices. The glass wear then displays the questions and answer choices via an AR overlay which is visible only to Jessica. The questions are ordered differently for different students. Jessica selects answers using a touch pad attached to the glass wear. The glass wear captures a fingerprint and submits the fingerprint to a server to again confirm that Jessica is in fact wearing the glass wear. The server confirms the fingerprint corresponds to Jessica. In response to receiving the confirmation from the server, the glass wear transmits Jessica's selected answer to the tablet. The tablet stores the response. Jessica answers additional questions by tapping the touch pad, scrolling up and down on a wheel, and/or performing gestures (e.g., sliding gestures or circular gestures on the touchpad). The tablet stores all of the answer choices selected by Jessica. Once the examination is completed, the tablet transmits the answers to a server which stores the answers for a professor to access and review at a later time. In addition, the tablet computes a probability of cheating based on all the biometric information collected by the glass wear and provides the probability of cheating with the selected answers for review by a professor. The probability of cheating is further based on detection of voices other than Jessica's in the vicinity of the glass wear.

### 5. Secure Examination Procedure

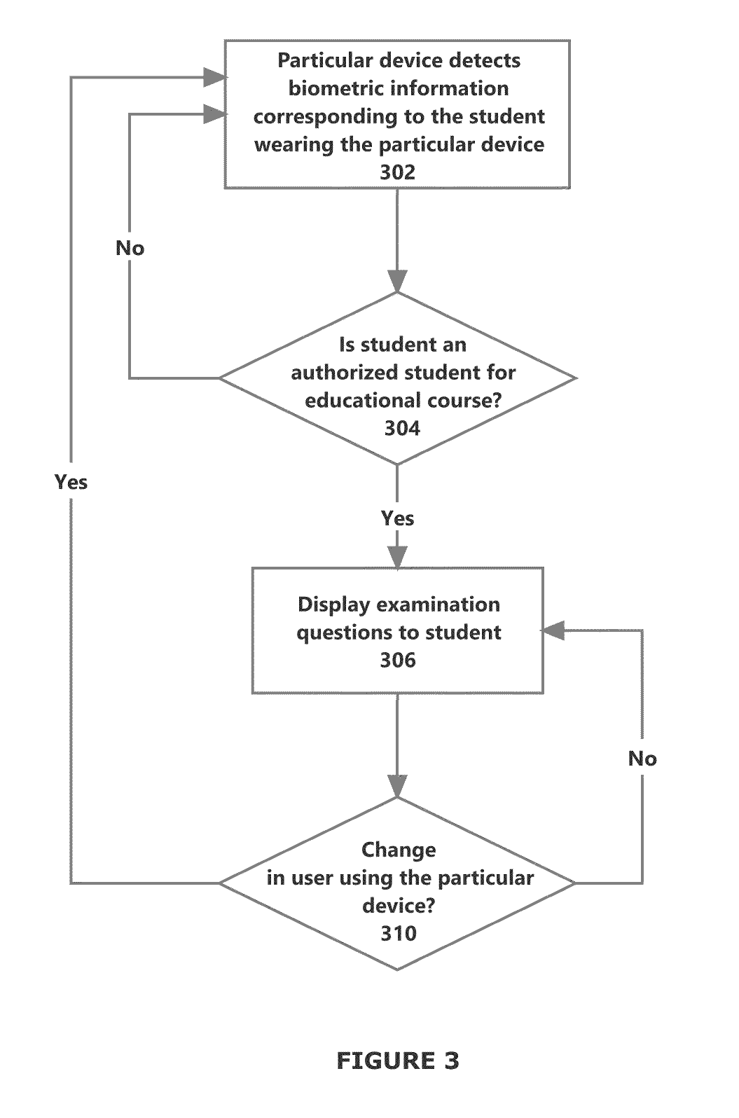

FIG. 3 illustrates an example set of operations for a secure examination procedure executed by a particular device. Operations, as described herein with reference to FIG. 3, may be omitted, rearranged, or modified. Furthermore, operations may be added or performed by components or devices different than the specifically mentioned components or devices. Accordingly, the specific set or sequence of operations should not be construed as limiting the scope of any of the embodiments.

In one embodiment, the particular device is communicatively coupled with other devices. The particular device includes a display screen such that information displayed on the display screen can only be deciphered by an operator wearing the particular device. Examples of the particular device are described above in Table 1.

In an embodiment, the particular device detects biometric information corresponding to a user wearing the particular device (Operation 302). The biometric information is verified to ensure that the user is an authorized student for an educational course (Operation 304). The biometric information may include, but is not limited to, fingerprint information, voice information, DNA information, and iris information.

The verification is performed by the particular device itself or by another device such as a server which receives the biometric information from the particular device. Performing the verification includes comparing the detected biometric information for the user to a database of biometric information corresponding to authorized students. If the biometric information for the user matches the biometric information for a particular authorized student, a determination is made that the user is the particular authorized student.

Responsive to completing successful verification of the user of the particular device as an authorized student in the course, the examination questions are displayed by the particular device to the student (Operation 306). In an example, the examination questions are not transmitted to the particular device until successful verification of the user as an authorized student is completed. When verification is successfully performed by a server, the server transmits a message to the particular device indicating that the user has been successfully verified. In an example, the examination questions are transmitted to the particular device prior to the successful verification and displayed subsequent to successful verification.

In an embodiment, a server in communication with the particular device transmits the questions to the particular device using an Internet Protocol (IP) address, Media Access Control (MAC) address, Bluetooth identifier, or other identifier associated with the particular device.

In an embodiment, biometric information is detected repeatedly by the particular device prior to displaying each question, or each set of questions. The biometric information is repeatedly verified to ensure that the user of the particular device has not changed. If a change in the user is detected (Operation 308), the questions are not displayed and alerts are transmitted to a professor or other administrator of the examination. In addition, the system may restart the process and identify the new user based on the biometric information of the new user. In an embodiment, biometric information is detected by the particular device prior to or concurrently with receiving user input comprising answers to examination questions. The answers are accepted by the system if the biometric information is successfully verified as corresponding to an authorized student.

In an embodiment, an examination to be taken in teams by students allows for any of the team members to take the exam. The verification operation is successfully completed as long as one of the team members is operating the particular device as determined by biometric data.

### 6. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

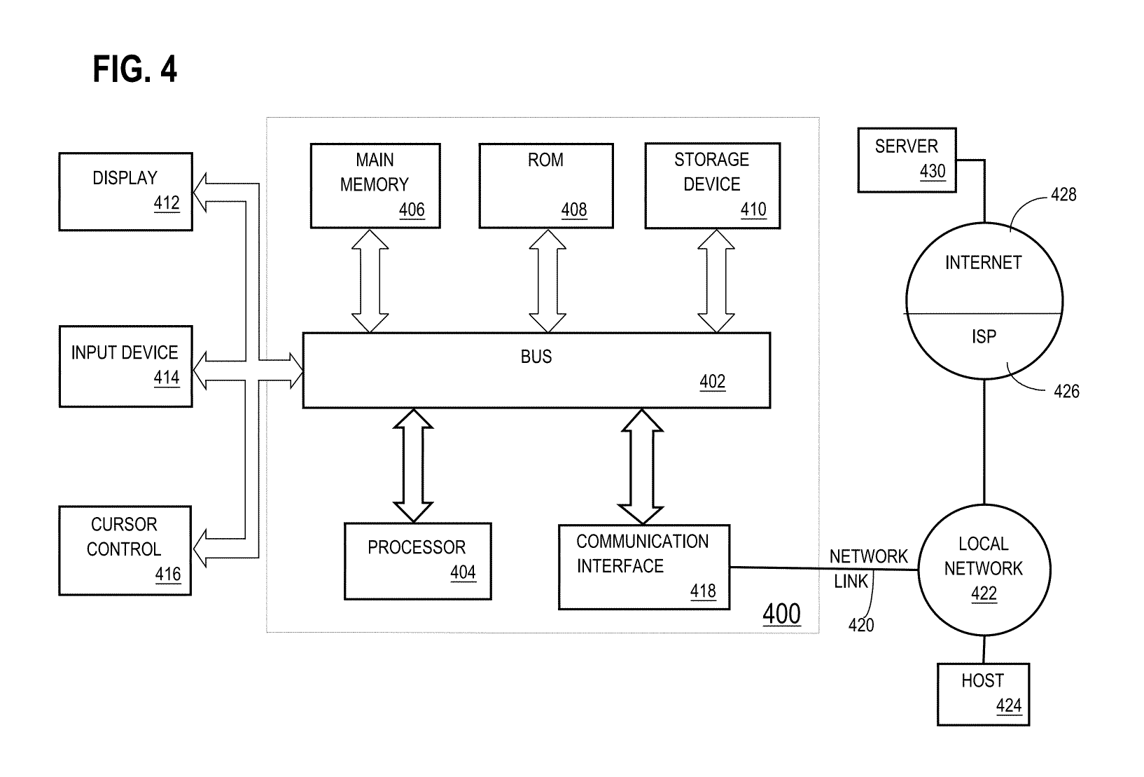

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 440, such as a magnetic disk or optical disk, is provided and coupled to bus 402 for storing information and instructions.

Computer system 400 may be coupled via bus 402 to a display 442, such as a cathode ray tube (CRT), for displaying information to a computer user. An input device 444, including alphanumeric and other keys, is coupled to bus 402 for communicating information and command selections to processor 404. Another type of user input device is cursor control 446, such as a mouse, a trackball, or cursor direction keys for communicating direction information and command selections to processor 404 and for controlling cursor movement on display 442. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 440. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 440. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 440 either before or after execution by processor 404.

Computer system 400 also includes a communication interface 448 coupled to bus 402. Communication interface 448 provides a two-way data communication coupling to a network link 420 that is connected to a local network 422. For example, communication interface 448 may be an integrated services digital network (ISDN) card, cable modem, satellite modem, or a modem to provide a data communication connection to a corresponding type of telephone line. As another example, communication interface 448 may be a local area network (LAN) card to provide a data communication connection to a compatible LAN. Wireless links may also be implemented. In any such implementation, communication interface 448 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 448, which carry the digital data to and from computer system 400, are example forms of transmission media.

Computer system 400 can send messages and receive data, including program code, through the network(s), network link 420 and communication interface 448. In the Internet example, a server 430 might transmit a requested code for an application program through Internet 428, ISP 426, local network 422 and communication interface 448.

The received code may be executed by processor 404 as it is received, and/or stored in storage device 440, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A non-transitory computer readable medium comprising instructions which, when executed by one or more hardware processors, causes performance of operations comprising:
detecting, by a first device, biometric information for an operator of the first device;
determining that the biometric information corresponds to an authorized entity;
responsive at least to determining that the biometric information corresponds to an authorized entity:
displaying, by the first device, data in a decrypted form that is concurrently displayed by a second device in an encrypted form.

2. The medium of claim 1, wherein the displaying operation comprises:
obtaining by the first device the data displayed by the second device in the encrypted form; and
decrypting the data in the encrypted form to obtain data in the decrypted form.

3. The medium of claim 1, wherein prior to the displaying operation, the operations further comprise:
receiving, by the second device, user input comprising log-in information for the operator;
determining that the log-in information corresponds to the authorized entity.

4. The medium of claim 1, wherein the biometric information comprises one or more of:
iris information;
fingerprint information;
voice information;
heart rate information; and
DNA information.

5. The medium of claim 1, wherein the data displayed by the second device in an encrypted form comprises an Augmented Reality (AR) image marker, and wherein the displaying operation comprises: displaying, by the first device, data identified by the AR image marker.

6. The medium of claim 1, wherein the data comprises one or more of: (a) questions and (b) answer choices.

7. The medium of claim 1, wherein the first device comprises a glass wear mobile device.

8. The medium of claim 1, wherein the first device comprises a screen viewable only by a user wearing the first device.

9. The medium of claim 1, wherein the operations further comprise:
periodically detecting, by the first device, additional biometric information for the operator of the first device;
determining that the additional biometric information corresponds to the authorized entity;
responsive at least to determining that the additional biometric information corresponds to the authorized entity:
displaying, by the first device, additional data in a decrypted form that is concurrently displayed by the second device in an encrypted form.

10. A non-transitory computer readable medium comprising instructions which, when executed by one or more hardware processors, causes performance of operations comprising:
detecting, by a particular device, biometric information for an operator of the particular device;
determining whether the biometric information corresponds to an authorized student associated with a particular educational course;
responsive at least to determining that the biometric information corresponds to an authorized student associated with the particular educational course: displaying, by the client device, data related to the particular educational course;
responsive at least to determining that the biometric information does not correspond to any authorized student associated with the particular educational course: refraining, by the particular device, from displaying data related to the particular educational course.

11. The medium of claim 10, wherein the operations further comprise:
subsequent to determining that the biometric information corresponds to the authorized student:
receiving, by the particular device, a decryption key;
wherein the data related to particular education course is decrypted by the particular device using the decryption key.

12. The medium of claim 10, wherein the particular device does not receive the data related to the particular educational course if the biometric information does not correspond to any authorized student associated with the particular educational course.

13. The medium of claim 10, wherein the operations further comprise:
periodically detecting, by the particular device, updated biometric information for the operator of the first device;
determining whether the updated biometric information corresponds to an authorized student associated with a particular educational course;
responsive at least to determining that the updated biometric information corresponds to an authorized student associated with the particular educational course: displaying, by the particular device, the data related to the particular educational course;
responsive at least to determining that the updated biometric information does not correspond to any authorized student associated with the particular educational course: refraining, by the particular device, from displaying data related to the particular educational course.

14. The medium of claim 10, wherein the operations further comprise:
prior to displaying each exam question and/or prior to accepting each exam answer from the operator of the first device:
detecting and verifying updated biometric information for the operator of the particular device.

15. A system comprising:
at least a first device including a hardware processor;
the system being configured to perform operations comprising:
detecting, by the first device, biometric information for an operator of the first device;
determining that the biometric information corresponds to an authorized entity;
responsive at least to determining that the biometric information corresponds to an authorized entity:
displaying, by the first device, data in a decrypted form that is concurrently displayed by a second device in an encrypted form.

16. The system of claim 15, wherein the displaying operation comprises:
obtaining by the first device the data displayed by the second device in the encrypted form; and
decrypting the data in the encrypted form to obtain data in the decrypted form.

17. The system of claim 15, wherein prior to the displaying operation, the operations further comprise:
receiving, by the second device, user input comprising log-in information for the operator;
determining that the log-in information corresponds to the authorized entity.

18. The system of claim 15, wherein the biometric information comprises one or more of:
iris information;
fingerprint information;
voice information;
heart rate information; and
DNA information.

19. The system of claim 15, wherein the data displayed by the second device in an encrypted form comprises an Augmented Reality (AR) image marker, and wherein the displaying operation comprises: displaying, by the first device, data identified by the AR image marker.

20. The system of claim 15, wherein the data comprises one or more of: (a) questions and (b) answer choices.

21. The system of claim 15, wherein the first device comprises a glass wear mobile device.
